(19) United States
(12) Patent Application Publication
(10) Pub. No.: US 2025/0112520 A1
(43) Pub. Date: Apr. 3, 2025

(54) DOUBLY FED INDUCTION MACHINE FOR SERIES HYBRID APPLICATIONS

(71) Applicant: Schaeffler Technologies AG & Co. KG, Herzogenaurach (DE)

(72) Inventor: Md. Wasi Uddin, Wooster, OH (US)

(73) Assignee: Schaeffler Technologies AG & Co. KG, Herzogenaurach (DE)

(21) Appl. No.: 18/374,286

(22) Filed: Sep. 28, 2023

(51) Int. Cl. H02K 7/00; H02K 13/00; H02K 17/22

(52) U.S. Cl. CPC H02K 7/006; H02K 13/003; H02K 17/22; H02K 2213/03

(57) ABSTRACT

A hybrid drivetrain for a vehicle includes a doubly fed induction machine, a first inverter and a second inverter. The doubly fed induction machine includes a stator with a plurality of stator windings and a rotor. The rotor includes a plurality of rotor windings and a plurality of slip rings electrically connected to the plurality of rotor windings. The first inverter is arranged to provide a first multi-phase power to the plurality of stator windings and the second is inverter arranged to provide a second multi-phase power to the plurality of rotor windings through the plurality of slip rings. In an example embodiment, the second multi-phase power is provided to the plurality of slip rings through a plurality of brushes. In an example embodiment, a quantity of the plurality of slip rings is exactly three.

### TECHNICAL FIELD

The present disclosure relates generally to an induction machine, and more specifically to a doubly fed induction machine for series hybrid applications.

### BACKGROUND

Double-fed asynchronous machines are known. One example is shown and described in European Patent Application No. EP 3 771 075 A1 titled “DOPPELT GESPEISTE ASYNCHRONMASCHINE MIT EINEM SCHLEIFRINGLÄUFER” (DOUBLE-FED ASYNCHRONOUS MACHINE WITH ONE SLIP RING ROTOR) to Siemens Aktiengesellschaft, hereby incorporated by reference as if set forth fully herein.

### SUMMARY

Example embodiments broadly comprise a hybrid drivetrain for a vehicle including a doubly fed induction machine, a first inverter and a second inverter. The doubly fed induction machine includes a stator with a plurality of stator windings and a rotor. The rotor includes a plurality of rotor windings and a plurality of slip rings electrically connected to the plurality of rotor windings. The first inverter is arranged to provide a first multi-phase power to the plurality of stator windings and the second is inverter arranged to provide a second multi-phase power to the plurality of rotor windings through the plurality of slip rings. In an example embodiment, the second multi-phase power is provided to the plurality of slip rings through a plurality of brushes. In an example embodiment, a quantity of the plurality of slip rings is exactly three.

In some example embodiments, the doubly fed induction machine has a first maximum power rating and the second inverter has a second maximum power rating that is 25-35% of the first maximum power rating. In an example embodiment, the hybrid drivetrain also includes a generator. The generator has a third maximum power rating and the third maximum power rating is equal to or greater than the first maximum power rating. In some example embodiments, the hybrid drivetrain also includes a generator arranged for driving connection to an internal combustion engine, and the generator is selectively electrically connected to the plurality of stator windings and to the first inverter. In an example embodiment, the generator is arranged to provide a third multi-phase power to the stator windings and to the first inverter and the first multi-phase power, the second multi-phase power and the third multi-phase power all have a same number of phases.

In some example embodiments, the hybrid drivetrain also includes a battery electrically connected to the first inverter and to the second inverter. In an example embodiment, the battery is arranged to provide a first direct current power to the first inverter and to the second inverter.

Other example aspects broadly comprise a hybrid drivetrain for a vehicle including an internal combustion engine, a doubly fed induction machine, a first inverter, a second inverter, a generator, a battery and at least one drive wheel. The doubly fed induction machine includes a stator with a plurality of stator windings and a rotor. The rotor includes a plurality of rotor windings and a plurality of slip rings electrically connected to the plurality of rotor windings. The first inverter arranged to provide a first multi-phase power to the plurality of stator windings and the second inverter is arranged to provide a second multi-phase power to the plurality of rotor windings through a plurality of brushes contacting the plurality of slip rings. The generator is drivingly connected to the internal combustion engine and arranged to provide a third multi-phase power to the stator windings and to the first inverter and the battery is arranged to provide a first direct current power to the first inverter and to the second inverter. The at least one drive wheel is drivingly connected to the rotor.

The present disclosure also provides a method of operating the hybrid drivetrain in a first motoring mode wherein the first inverter is arranged to provide a second direct current power to the second inverter. The method includes driving the generator with the internal combustion engine, providing the third multi-phase power from the generator to the stator windings and to the first inverter, providing the second direct current power from the first inverter to the second inverter, providing the second multi-phase power from the second inverter to the rotor windings to adjust an electrical slip of the doubly fed induction machine to be greater than zero, and driving the at least one drive wheel with the rotor.

The present disclosure also provides a method of operating the hybrid drivetrain in a second motoring mode including driving the generator with the internal combustion engine, providing the third multi-phase power from the generator to the stator windings, providing the first direct current power from the battery to the first inverter and to the second inverter, providing the first multi-phase power from the first inverter to the stator windings, providing the second multi-phase power from the second inverter to the rotor windings to adjust an electrical slip of the doubly fed induction machine to be less than zero, and driving the at least one drive wheel with the rotor.

The present disclosure also provides a method of operating the hybrid drivetrain in a regeneration mode wherein the stator is arranged to provide a fourth multi-phase power to the first inverter and the first inverter is arranged to provide a second direct current power to the battery. The method includes driving the rotor with the at least one drive wheel, providing the fourth multi-phase power from the stator to the first inverter, providing the second direct current power from the first inverter to the battery and to the second inverter and providing the second multi-phase power from the second inverter to the rotor windings to adjust an electrical slip of the doubly fed induction machine to be greater than zero.

The present disclosure also provides a method of operating the hybrid drivetrain in an electric driving mode including providing the first direct current power from the battery to the first inverter and to the second inverter, providing the first multi-phase power from the first inverter to the stator windings, providing the second multi-phase power from the second inverter to the rotor windings to adjust an electrical slip of the doubly fed induction machine to be less than zero, and driving the at least one drive wheel with the rotor. In an example embodiment, the method also includes electrically disconnecting the generator from the stator windings and from the first inverter. In an example embodiment, the method also includes providing a fifth multi-phase power from the first inverter to the generator to rotate the generator and start the internal combustion engine.

The present disclosure also provides a method of operating the hybrid drivetrain to start the internal combustion engine including providing the first direct current power from the battery to the first inverter and providing a fifth multi-phase power from the first inverter to the generator to rotate the generator and start the internal combustion engine. In an example embodiment, the second multi-phase power is not provided by the second inverter to the rotor windings.

### BRIEF DESCRIPTION OF THE DRAWINGS

FIG. 1 illustrates a perspective view of a prior art doubly fed induction machine with a portion of a housing removed for clarity.

FIG. 2 illustrates a schematic view of a hybrid drivetrain according to an example embodiment.

FIG. 3A is a schematic view of power entering and exiting the rotor and stator during subsynchronous generation mode.

FIG. 3B is a schematic view of power entering and exiting the rotor and stator during supersynchronous generation mode.

FIG. 3C is a schematic view of power entering and exiting the rotor and stator during subsynchronous motoring mode.

FIG. 3D is a schematic view of power entering and exiting the rotor and stator during supersynchronous motoring mode.

FIG. 4A illustrates a schematic view of a hybrid drivetrain operating in a subsynchronous hybrid motoring mode without battery power.

FIG. 4B illustrates a schematic view of a hybrid drivetrain operating in a supersynchronous hybrid motoring mode without battery power.

FIG. 5A illustrates a schematic view of a hybrid drivetrain operating in a subsynchronous hybrid motoring mode with battery power.

FIG. 5B illustrates a schematic view of a hybrid drivetrain operating in a supersynchronous hybrid motoring mode with battery power.

FIG. 6A illustrates a schematic view of a hybrid drivetrain operating in a subsynchronous regeneration mode (e.g., during vehicle coasting).

FIG. 6B illustrates a schematic view of a hybrid drivetrain operating in a supersynchronous regeneration mode (e.g., during vehicle coasting).

FIG. 7A illustrates a schematic view of a hybrid drivetrain operating in a subsynchronous electric driving mode.

FIG. 7B illustrates a schematic view of a hybrid drivetrain operating in a supersynchronous electric driving mode.

FIG. 8 illustrates a schematic view of a hybrid drivetrain operating in an internal combustion engine start mode when the vehicle is stopped.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

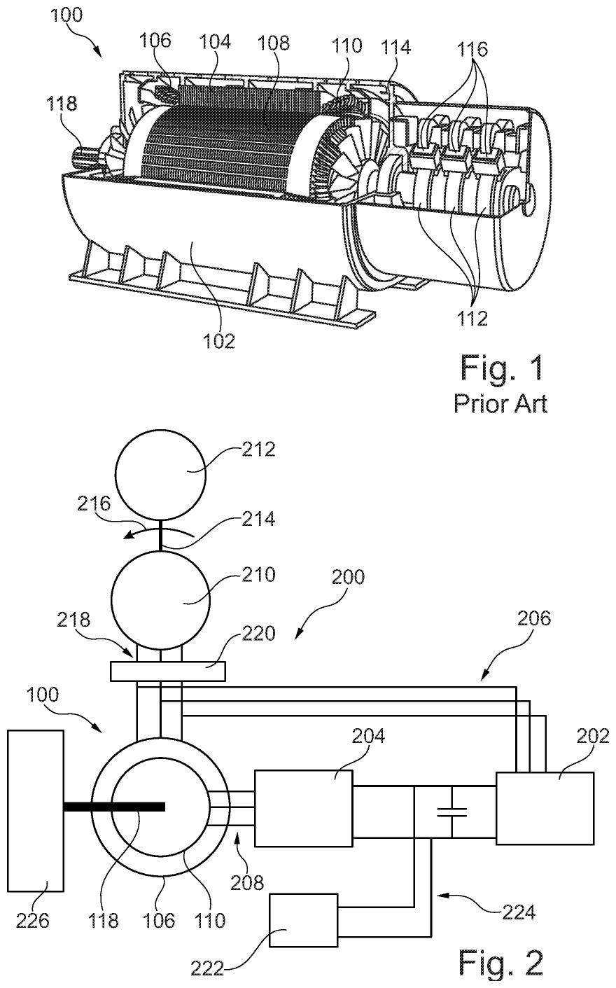

The following description is made with reference to FIG. 1. FIG. 1 illustrates a perspective view of prior art doubly fed induction machine 100 with a portion of housing 102 removed for clarity. Doubly fed induction machine 100 includes stator 104 with stator windings 106, fixed in housing 102, and rotor 108 with rotor windings 110. Rotor 108 also includes slip rings 112 electrically connected to the rotor windings. The slip rings may be separated from the rotor windings by bulkhead 114. Brushes 116 are rotationally stationary in housing 102 and transmit electrical power to slip rings 112 as described in more detail below. Rotor 108 also includes rotor shaft 118. Shaft 118 may be sealed to the bulkhead and rotatably supported in the housing by bearings (not shown).

The following description is made with reference to FIGS. 1-2. FIG. 2 is a schematic view of hybrid drivetrain 200 according to an example embodiment. Hybrid drivetrain 200 includes doubly fed induction machine 100 and inverters 202 and 204. Inverter 202 is arranged to provide multi-phase power to the stator windings (via multi-phase electrical conductors 206, for example) and inverter 204 is arranged to provide multi-phase power to the rotor windings through slip rings 112 (via multi-phase electrical conductors 208, for example). By multi-phase, I mean that power is supplied as separate alternating currents of a same voltage with phases evenly distributed through a period. As an example, for three-phase power, all three of the conductors carry power at a same voltage and frequency, but a phase of each power is offset by one third of a period (i.e., 120°). Thus, when one phase is at a maximum positive current, the other two phases are at a negative current. By electrical conductors, I mean copper or aluminum wires, busbars, or other known conductors, or combinations thereof.

It should be noted that inverters 202 and 204 may be operated bi-directionally. For example, a common use of inverters is to invert 12-volt direct current power into 120-volt alternating current to power a laptop or television from a vehicle battery. By contrast, converters are commonly used to convert 120-volt alternating current power to 12-volt direct current power to charge a vehicle battery at home or power recreational vehicle lights and 12-volt appliances from campground power outlets. Here, however, inverters 202 and 204 can be used to invert direct current (e.g., from a battery) to alternating current (e.g., to power an induction motor) AND they can also be used to convert alternating current (e.g., from a generator) to direct current (e.g., to charge a battery). It should also be noted that inverters 202 and 204, although shown as separate components, may be integrated into a single device.

Multi-phase power is provided to slip rings 112 through brushes (e.g., brushes 118 described above). In the example shown, there are exactly three slip rings 112 (one for each phase of a three-phase power). Although the example shown uses three-phase power, other types of multi-phase power are possible. For example, an embodiment (not shown) may have six slip rings and the power may be provided in six phases. In this case, each inverter would be connected to respective components via six conductors, for example.

Hybrid drivetrain 200 also includes generator 210 arranged for driving connection to internal combustion engine 212 (e.g., mechanically connected). That is, the generator includes generator shaft 214 coupled to the combustion engine so that, when the shaft is rotated by the combustion engine (as indicated by rotation arrow 216), the generator produces multi-phase power. Generator 210 may be similar to a conventional induction motor operating in reverse (e.g., generator mode), for example, and is designed with the same number of phases as doubly fed induction machine 100. Generator 210 may also be a permanent magnet device. Generator 210 is selectively electrically connected to stator windings 106 and inverter 202 via multi-phase electrical conductors 218 and breaker, or disconnect, 220, for example, and arranged to provide multi-phase power to the stator windings and to inverter 202. Multi-phase power of inverters 202 and 204, and generator 210, all have a same number of phases.

In the arrangement shown, doubly fed induction machine 100 has a maximum power rating and inverter 204 has a maximum power rating that is only 25-35% of the maximum power rating of doubly fed induction machine 100. Inverter 202 has a continuous power rating that is equal to or slightly greater than the maximum power rating of inverter 204 to continuously supply inverter 204 with direct current power. Generator 210 has a maximum power rating equal to or greater than the maximum power rating of the doubly fed induction machine. Inverter 202 has a maximum power rating selected to meet or exceed regeneration power from generator 210. Inverter 202 has a lower continuous power rating and inverter 204 has a lower maximum power rating due to the operation method described below. This provides efficiencies in size, cost, and necessary cooling for hybrid drivetrain 200.

Hybrid drivetrain 200 also includes battery 222 electrically connected to inverter 202 and inverter 204 via direct current electrical conductors 224. Battery 222 is arranged to provide direct current power to inverters 202 and 204. As opposed to alternating current, direct current only requires two conductors, a positive conductor and a negative conductor, and the current flows in one direction only.

In an example embodiment, hybrid drivetrain 200 includes internal combustion engine 212, doubly fed induction machine 100 with stator 104, including stator windings 106, and rotor 108, including rotor windings 110 and slip rings 112 electrically connected to the rotor windings, inverter 202 arranged to provide multi-phase power to the stator windings, inverter 204 arranged to provide multi-phase power to the rotor windings through the slip rings, generator 210 drivingly connected to the internal combustion engine and arranged to provide multi-phase power to the stator windings and to inverter 202, battery 222 arranged to provide direct current power to inverters 202 and 204, and drive wheel 226 drivingly connected to the rotor (through rotor shaft 118, for example). Hybrid drivetrain 200 may be employed in a series-hybrid vehicle with doubly fed induction machine 100 installed in an electric axle (not shown), for example.

During motoring or generating, acceleration at steady state is defined by the following equation:

$$J \frac{d ω}{dt} = {T}_{m} - {T}_{s} = 0$$

where J is the moment of inertia of the rotor, dw/dt is the change in angular velocity of the rotor over time, Tₘ is shaft torque and Tₛ is stator (electromagnetic) torque. Electrical slip is defined by the following equation:

$$s = \frac{{ω}_{s} - {ω}_{r}}{{ω}_{s}} = 1 - \frac{{ω}_{r}}{{ω}_{s}}$$

where s is the electrical slip, ωᵣ is a rotational speed of the rotor, and ωₛ is the speed of excitation.

During generation mode, the rotor power is defined by the following equation:

$${P}_{r} = {P}_{m} - {P}_{s} = {T}_{m} {ω}_{r} - {T}_{s} {ω}_{s} = - {T}_{s} ( {ω}_{s} - {ω}_{r} ) = - {T}_{s} s {ω}_{s} = - {sP}_{s}$$

where Pᵣ is rotor power, Pₘ is shaft power and Pₛ is stator power. The remaining terms are defined above. Subsynchronous modes are defined as electrical slip greater than zero (e.g., rotor rotating slower than excitation) and supersynchronous modes are defined as electrical slip less than zero (e.g., rotor rotating faster than excitation). Similarly, during motoring mode, the rotor power is defined by the following equation:

$${P}_{r} = {P}_{s} - {P}_{m} = {T}_{s} {ω}_{s} - {T}_{m} {ω}_{r} = {T}_{s} ( {ω}_{s} - {ω}_{r} ) = {T}_{s} s {ω}_{s} = {sP}_{s}$$

with all terms defined above. A summary of the above discussion is provided in the table below:

| | Generating, Pₛ < 0 | Motoring, Pₛ > 0 |
|---|---|---|
| Subsynchronous, s > 0 | Pᵣ = −s * Pₛ | Pᵣ = s * Pₛ |
| | (consumed by rotor) | (supplied by rotor) |
| Supersynchronous, s < 0 | Pᵣ = −s * Pₛ | Pᵣ = s * Pₛ |
| | (supplied by rotor) | (consumed by rotor) |

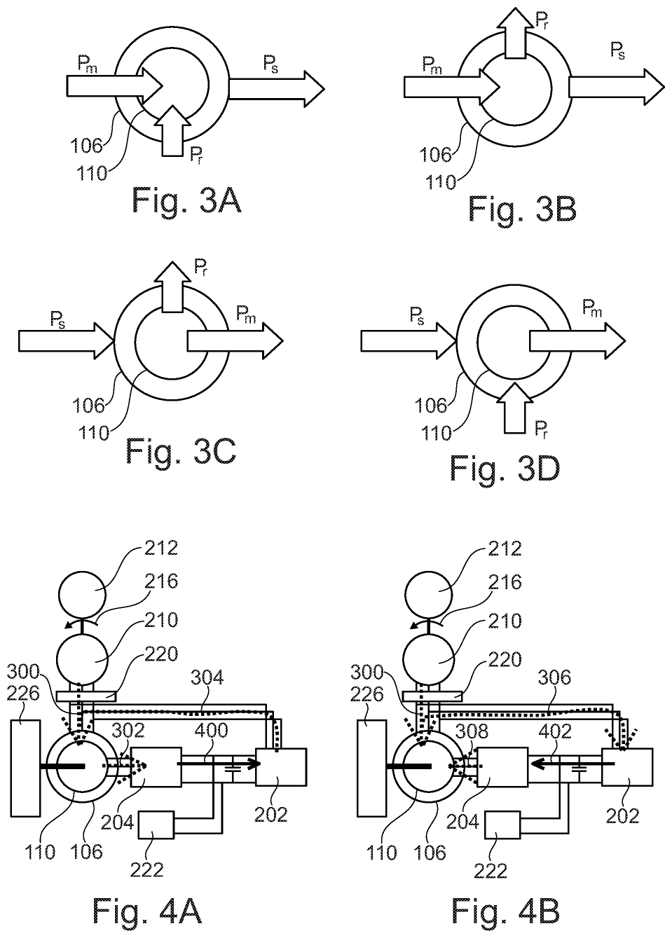

The following description is made with reference to FIGS. 3A-3B. FIG. 3A is a schematic view of power entering and exiting the rotor and stator during subsynchronous generation mode and FIG. 3B is a schematic view of power entering and exiting the rotor and stator during supersynchronous generation mode. More detail about generation mode will be discussed below. As can be seen in FIG. 3A, during subsynchronous generation, shaft power (e.g., from axle 118 discussed above) is available at the rotor and rotor electrical power (e.g., from inverter 204 discussed above) is supplied to rotor windings 110 and a sum of shaft power and rotor electrical power is recovered from stator windings 106. During supersynchronous generation (FIG. 3B), however, only shaft power is available at the rotor. The rotor windings supply power out (through inverter 204 discussed above) and a difference between the shaft power and the rotor electrical power is recovered. Hence, more regeneration power is produced when the doubly fed induction machine is operated in supersynchronous mode.

The following description is made with reference to FIGS. 3C-3D. FIG. 3C is a schematic view of power entering and exiting the rotor and stator during subsynchronous motoring mode and FIG. 3D is a schematic view of power entering and exiting the rotor and stator during supersynchronous motoring mode. As can be seen in FIG. 3C, during subsynchronous motoring, Stator power available at the stator windings and rotor windings 110 supplies power out (e.g., to inverter 204 discussed above) and a difference between stator power and rotor power is available at the shaft (e.g., to drive axle 118 discussed above) as motoring power. During supersynchronous motoring (FIG. 3D), however, stator power is available at the stator windings 106 and rotor electrical power is supplied to rotor windings 110. A sum of stator power and rotor electrical power is available at the shaft for motoring. Hence, less input power is required for motoring when the doubly fed induction machine is operated in subsynchronous mode.

Methods of operating hybrid drivetrain 200 will now be discussed with reference to FIGS. 4-9. The following description is made with reference to FIGS. 4A-4B. FIG. 4A illustrates a schematic view of hybrid drivetrain 200 operating in a subsynchronous hybrid motoring mode without battery power. FIG. 4B illustrates a schematic view of hybrid drivetrain 200 operating in a supersynchronous hybrid motoring mode without battery power. In the mode shown in FIG. 4A, the generator is driven by the internal combustion engine (as indicated by rotation arrow 216) and multi-phase power from the generator is provided to the stator windings (as indicated by dashed arrow 300). Multi-phase power (dashed arrow 302) from rotor windings 106 is converted to direct current power (solid arrow 400) by inverter 204 and provided to stator windings 110 as multi-phase power (dashed arrow 304) from inverter 202. Drive wheel 226 is driven by rotor 108. Although only one drive wheel 226 is shown, multiple drive wheels connected to the rotor through the electric axle or other drivetrain of the vehicle are possible.

In the mode shown in FIG. 4B, the generator is driven by the internal combustion engine (as indicated by rotation arrow 216) and multi-phase power from the generator is provided to the stator windings and to inverter 202 (as indicated by dashed arrows 300 and 306, respectively). Direct current power from inverter 202 is provided to inverter 204 (as indicated by solid arrow 402) and multi-phase power is provided from inverter 204 to the rotor windings (as indicated by dashed arrow 308) to adjust an electrical slip of the doubly fed induction machine to be less than zero (i.e., supersynchronous). Drive wheel 226 is driven by rotor 108. Typical values of electrical slip are around 5%, with very short periods of electrical slip as high as 30% during transient events.

By electrical slip, I mean the difference between a rotational speed of the rotor and excitation of a magnetic field in the stator. In the above example, the generator is operating at a speed proportional to a speed of the internal combustion engine (or at exactly the speed of the internal combustion engine) and providing an alternating current to the stator windings proportional to that frequency. If the combustion engine speeds up or slows down, so does the magnetic field in the stator since it is controlled by the alternating current provided by the generator. Similarly, the magnetic field in the rotor is controlled by the alternating current provided by inverter 204. Since the inverter is an electric component and not mechanically driven, inverter 204 can adjust an alternating current provided to the rotor, thereby controlling a speed of the magnetic field (equal to the slip speed) and direction of power in the rotor windings.

When electrical slip is greater than zero, excitation is greater than a rotational speed of the rotor and the doubly fed induction machine produces a motoring torque Tₘ.

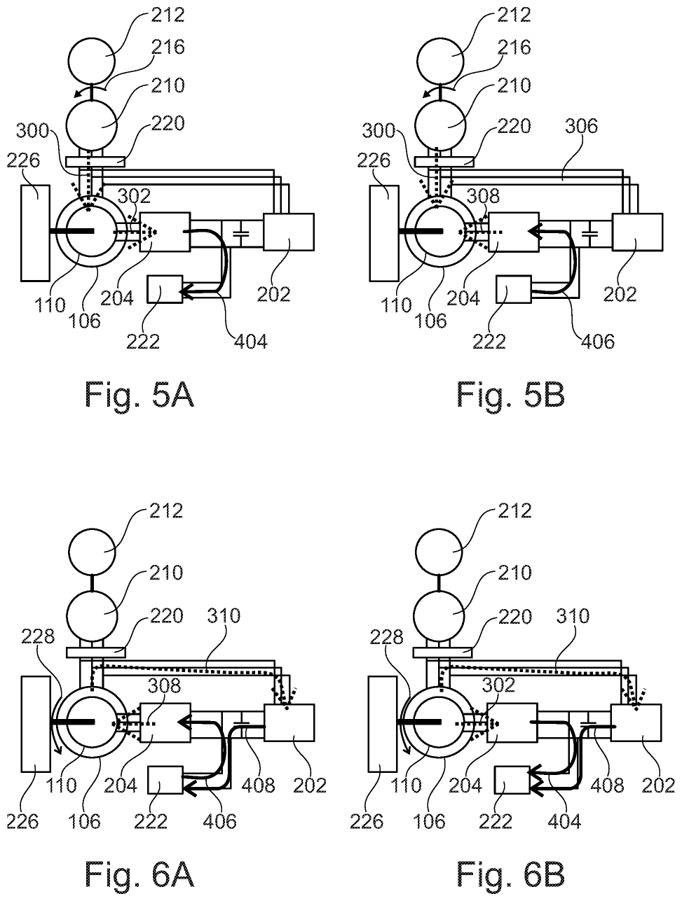

The following description is made with reference to FIGS. 5A and 5B. FIG. 5A illustrates a schematic view of hybrid drivetrain 200 operating in a subsynchronous hybrid motoring mode with battery power. FIG. 5B illustrates a schematic view of hybrid drivetrain 200 operating in a supersynchronous hybrid motoring mode with battery power. In the mode shown in FIG. 5A, the generator is driven by the internal combustion engine (as indicated by rotation arrow 216) and multi-phase power from the generator is provided to the stator windings (as indicated by dashed arrow 300). Multi-phase power from the rotor windings is provided to inverter 202 (as indicated by solid arrow 302) which provides direct current power to battery 222 (as indicated by solid arrow 404). Drive wheel 226 is driven by rotor 108.

In the mode shown in FIG. 5B, the generator is driven by the internal combustion engine (as indicated by rotation arrow 216) and multi-phase power from the generator is provided to the stator windings (as indicated by dashed arrow 300). Direct current power from the battery is provided to inverter 204 (as indicated by solid arrow 406). Multi-phase power is provided from inverter 204 to the rotor windings (as indicated by dashed arrow 308) to adjust an electrical slip of the doubly fed induction machine to be less than zero. Drive wheel 226 is driven by rotor 108.

The following description is made with reference to FIGS. 6A and 6B. FIG. 6A illustrates a schematic view of hybrid drivetrain 200 operating in a subsynchronous regeneration mode (e.g., during vehicle coasting). FIG. 6B illustrates a schematic view of hybrid drivetrain 200 operating in a supersynchronous regeneration mode (e.g., during vehicle coasting). In the mode shown in FIG. 6A, rotor 108 is driven by drive wheel 226 (as indicated by rotation arrow 228). Stator windings 106 are arranged to provide a multi-phase power to inverter 202 (as indicated by dashed arrow 310) and inverter 202 is arranged to provide a direct current power to battery 222 (as indicated by solid arrow 408). Battery 222 supplies direct current power to inverter 204 (as indicated by solid arrow 406) and multi-phase power is provided from inverter 204 to the rotor windings (as indicated by arrow 308) to adjust an electrical slip of the doubly fed induction machine to be greater than zero.

In the mode shown in FIG. 6B, rotor 108 is driven by drive wheel 226 (as indicated by rotation arrow 228). Stator windings 106 are arranged to provide a multi-phase power to inverter 202 (as indicated by dashed arrow 310) and inverter 202 is arranged to provide a direct current power to battery 222 (as indicated by solid arrow 408). Multi-phase power is provided from the rotor windings to inverter 204 (as indicated by dashed arrow 302) and direct current power is provided from inverter 204 to battery 222 (as indicated by solid arrow 404).

During regeneration mode, electrical slip s and power through the air gap P_{gap} is less than zero, and generator power P_{g} is zero since the internal combustion engine is not running and the generator is not rotating. Therefore, without considering losses (e.g., copper losses) in the doubly fed induction machine, power in inverter 204 is equal to the rotor excitation power Pᵣ and power in inverter 202 is equal to the of the rotor excitation power Pᵣ and the power through the air gap P_{gap}. Disconnect 220 is open during regeneration mode when the engine is not running to prevent multi-phase power being used to operate generator 210.

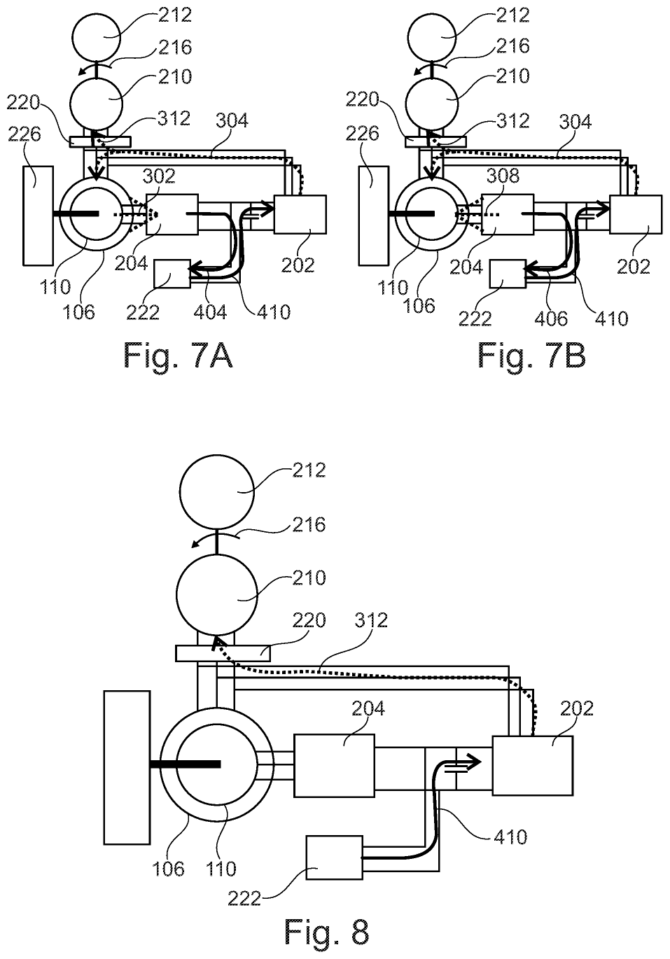

The following description is made with reference to FIGS. 7A-7B. FIG. 7A illustrates a schematic view of hybrid drivetrain 200 operating in a subsynchronous electric driving mode. FIG. 7B illustrates a schematic view of hybrid drivetrain 200 operating in a supersynchronous electric driving mode. Electric driving mode is similar to operation in hybrid motoring mode with battery power described above and shown in FIGS. 5A and 5B. Here, however, only the battery is supplying power to propel the vehicle. In this mode, the generator may be electrically disconnected from the stator windings and from inverter 202 by opening breaker 220. In the mode shown in FIG. 7A, direct current power is provided from the battery to inverter 202 (as indicated by solid arrow 410). Multi-phase power is provided from inverter 202 to the stator windings (as indicated by dashed arrow 304) and multi-phase power is provided from the rotor windings to inverter 204 (as indicated by dashed arrow 302). Direct current power is provided by inverter 204 to the battery (as indicated by solid arrow 406). Drive wheel 226 is driven by rotor 108.

In the mode shown in FIG. 7B, direct current power is provided from the battery to inverter 202 and to inverter 204 (as indicated by solid arrows 410 and 406, respectively). Multi-phase power is provided from inverter 202 to the stator windings (as indicated by dashed arrow 304) and multi-phase power is provided from inverter 204 to the rotor windings (as indicated by dashed arrow 308) to adjust an electrical slip of the doubly fed induction machine to be less than zero. Drive wheel 226 is driven by rotor 108.

During operation in either electric driving mode described above, the internal combustion engine may be started by closing breaker 220 and providing multi-phase power from inverter 202 to the generator (as indicated by dashed arrow 312) to rotate the generator and start the internal combustion engine.

The following description is made with reference to FIG. 8. FIG. 8 illustrates a schematic view of hybrid drivetrain 200 operating in an internal combustion engine start mode when the vehicle is stopped. In the mode shown in FIG. 8, direct current power is provided from battery 222 to inverter 202 (as indicated by solid arrow 410) and multi-phase power is provided from inverter 202 to generator 210 (as indicated by dashed arrow 312) to rotate the generator (as indicated by arrow 216) and start internal combustion engine 212. In this mode, multi-phase power is not provided by inverter 204 to the rotor windings.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### REFERENCE NUMERALS

100 Doubly fed induction machine
102 Housing
104 Stator
106 Stator windings
108 Rotor
110 Rotor windings
112 Slip rings
114 Bulkhead
116 Brushes
118 Rotor shaft
200 Hybrid drivetrain
202 Inverter (first)
204 Inverter (second)
206 Multi-phase electrical conductors
208 Multi-phase electrical conductors
210 Generator
212 Internal combustion engine
214 Generator shaft
216 Rotation arrow
218 Multi-phase electrical conductors
220 Breaker (disconnect)
222 Battery
224 Direct current electrical conductors
226 Drive wheel
300 Multi-phase power arrow (generator to stator windings)
302 Multi-phase power arrow (rotor windings to inverter 204)
304 Multi-phase power arrow (inverter 202 to stator windings)
306 Multi-phase power arrow (generator to inverter 202)
308 Multi-phase power arrow (inverter 204 to rotor windings)
310 Multi-phase power arrow (stator windings to inverter 202)
312 Multi-phase power arrow (inverter 202 to generator)
400 Direct current power arrow (inverter 204 to inverter 202)
402 Direct current power arrow (inverter 202 to inverter 204)
404 Direct current power arrow (inverter 204 to battery)
406 Direct current power arrow (battery to inverter 204)
408 Direct current power arrow (inverter 202 to battery)
410 Direct current power arrow (battery to inverter 202)

What is claimed is:

1. A hybrid drivetrain for a vehicle, comprising:
a doubly fed induction machine comprising:
a stator comprising a plurality of stator windings; and
a rotor comprising:
a plurality of rotor windings; and
a plurality of slip rings electrically connected to the plurality of rotor windings;
a first inverter arranged to provide a first multi-phase power to the plurality of stator windings; and
a second inverter arranged to provide a second multi-phase power to the plurality of rotor windings through the plurality of slip rings.

2. The hybrid drivetrain of claim 1 wherein the second multi-phase power is provided to the plurality of slip rings through a plurality of brushes.

3. The hybrid drivetrain of claim 1 wherein a quantity of the plurality of slip rings is exactly three.

4. The hybrid drivetrain of claim 1 wherein:
the doubly fed induction machine comprises a first maximum power rating; and
the second inverter comprises a second maximum power rating that is 25-35% of the first maximum power rating.

5. The hybrid drivetrain of claim 4 further comprising a generator, wherein:
the generator comprises a third maximum power rating; and
the third maximum power rating is equal to or greater than the first maximum power rating.

6. The hybrid drivetrain of claim 1 further comprising a generator arranged for driving connection to an internal combustion engine, wherein the generator is selectively electrically connected to the plurality of stator windings and to the first inverter.

7. The hybrid drivetrain of claim 6 wherein:
the generator is arranged to provide a third multi-phase power to the stator windings and to the first inverter; and
the first multi-phase power, the second multi-phase power and the third multi-phase power all have a same number of phases.

8. The hybrid drivetrain of claim 1 further comprising a battery electrically connected to the first inverter and to the second inverter.

9. The hybrid drivetrain of claim 8 wherein the battery is arranged to provide a first direct current power to the first inverter and to the second inverter.

10. A hybrid drivetrain for a vehicle, comprising:
an internal combustion engine;
a doubly fed induction machine comprising:
a stator comprising a plurality of stator windings; and
a rotor comprising:
a plurality of rotor windings; and
a plurality of slip rings electrically connected to the plurality of rotor windings;
a first inverter arranged to provide a first multi-phase power to the plurality of stator windings;
a second inverter arranged to provide a second multi-phase power to the plurality of rotor windings through a plurality of brushes contacting the plurality of slip rings;
a generator drivingly connected to the internal combustion engine and arranged to provide a third multi-phase power to the stator windings and to the first inverter;
a battery arranged to provide a first direct current power to the first inverter and to the second inverter; and
at least one drive wheel drivingly connected to the rotor.

11. A method of operating the hybrid drivetrain of claim 10 in a first motoring mode wherein the first inverter is arranged to provide a second direct current power to the second inverter, the method comprising:
driving the generator with the internal combustion engine;
providing the third multi-phase power from the generator to the stator windings and to the first inverter;
providing the second direct current power from the first inverter to the second inverter;
providing the second multi-phase power from the second inverter to the rotor windings to adjust an electrical slip of the doubly fed induction machine to be greater than zero; and
driving the at least one drive wheel with the rotor.

12. A method of operating the hybrid drivetrain of claim 10 in a second motoring mode comprising:
driving the generator with the internal combustion engine;
providing the third multi-phase power from the generator to the stator windings;
providing the first direct current power from the battery to the first inverter and to the second inverter;
providing the first multi-phase power from the first inverter to the stator windings;
providing the second multi-phase power from the second inverter to the rotor windings to adjust an electrical slip of the doubly fed induction machine to be less than zero; and
driving the at least one drive wheel with the rotor.

13. A method of operating the hybrid drivetrain of claim 10 in a regeneration mode wherein:
the stator is arranged to provide a fourth multi-phase power to the first inverter; and
the first inverter is arranged to provide a second direct current power to the battery, the method comprising:
driving the rotor with the at least one drive wheel;
providing the fourth multi-phase power from the stator to the first inverter;
providing the second direct current power from the first inverter to the battery and to the second inverter; and
providing the second multi-phase power from the second inverter to the rotor windings to adjust an electrical slip of the doubly fed induction machine to be greater than zero.

14. A method of operating the hybrid drivetrain of claim 10 in an electric driving mode comprising:
providing the first direct current power from the battery to the first inverter and to the second inverter;
providing the first multi-phase power from the first inverter to the stator windings;
providing the second multi-phase power from the second inverter to the rotor windings to adjust an electrical slip of the doubly fed induction machine to be less than zero; and
driving the at least one drive wheel with the rotor.

15. The method of claim 14 further comprising electrically disconnecting the generator from the stator windings and from the first inverter.

16. The method of claim 14 further comprising providing a fifth multi-phase power from the first inverter to the generator to rotate the generator and start the internal combustion engine.

17. A method of operating the hybrid drivetrain of claim 10 to start the internal combustion engine comprising:
providing the first direct current power from the battery to the first inverter; and
providing a fifth multi-phase power from the first inverter to the generator to rotate the generator and start the internal combustion engine.

18. The method of claim 17 wherein the second multi-phase power is not provided by the second inverter to the rotor windings.
